(19) United States
(12) Patent Application Publication
(10) Pub. No.: US 2005/0252727 A1
(43) Pub. Date: Nov. 17, 2005

(54) Brake pad wear indicator

(76) Inventors: Tom Peter England, Newport (GB); Paul Anthony Thomas, Caldicot (GB); Paul Roberts, Newport (GB); Simon Fisher, Abergavenny (GB)

Correspondence Address: CARLSON, GASKEY & OLDS, P.C., 400 WEST MAPLE ROAD, SUITE 350, BIRMINGHAM, MI, 48009, US

(21) Appl. No.: 11/127,807

(22) Filed: May 12, 2005

(30) Foreign Application Priority Data
May 13, 2004 (GB) 0410659.7

(51) Int. Cl. F16D 66/00

(52) U.S. Cl. 188/1.11 L

(57) ABSTRACT

A brake assembly includes a caliper, a brake pad, an actuator to force the brake pad into engagement with a rotor and an adjuster mechanism to compensate for wear of the brake pad. The adjuster mechanism includes a rotating component that rotates substantially in proportion to wear of the brake pad and is manually operable to deadjust the adjuster mechanism when replacement of the brake pad is required. The rotating component is operably coupled to a pad wear indicator mounted on the caliper which visually indicates an amount of brake pad wear.

### REFERENCE TO RELATED APPLICATIONS

This application claims priority to United Kingdom Patent Application No. 0410659.7 filed on May 13, 2004.

### BACKGROUND OF THE INVENTION

The present invention relates generally to a brake pad wear indicator, in particular for use on disc brake assemblies of heavy vehicles such as trucks and buses.

Wear indicators are known wherein movement of a floating brake caliper (also known as a sliding brake caliper) in an inboard direction as an outboard pad wears can be detected by a wear indicator, allowing a comparison between a position of the floating caliper and a position of the fixed carrier upon which the floating caliper is slideably mounted to be made. However, such wear indicators do not take into account the wear of the inboard pad.

### SUMMARY OF THE INVENTION

A brake assembly includes a calliper, a brake pad, an actuator to force the brake pad into engagement with a rotor and an adjuster mechanism to compensate for wear of the brake pad. The adjuster mechanism includes a rotating component that rotates substantially in proportion to wear of the brake pad and is manually operable to deadjust the adjuster mechanism when replacement of the brake pad is required. The rotating component is operably coupled to a pad wear indicator mounted on the calliper which visually indicates an amount of brake pad wear.

An object of the present invention is to provide an alternative brake pad wear indicator. When used with a floating caliper brake, another object of the present invention is to provide a brake pad wear indicator that indicates the wear of both friction pads.

Another object of the present invention is to provide a brake pad wear indicator that can be retrofitted onto brake assemblies which either do not have brake pad wear indicators or have the above mentioned known wear indicator.

Thus, the present invention provides a brake assembly, a wear indicator assembly, and a repair kit.

### BRIEF DESCRIPTION OF THE DRAWINGS

The invention will now be described, by way of example only, with reference to the accompanying drawings in which:

FIG. 1 is an isometric view of part of a known brake caliper having a known wear indicator;

FIG. 2 is a schematic view of the brake caliper of FIG. 1;

FIG. 3 is a view of a prior art brake caliper including an adjusting mechanism;

FIG. 4 is a cross section view of a wear indicator assembly according to the present invention;

FIG. 5 is an isometric view of the wear indicator assembly of FIG. 4;

FIG. 6 is a cross section view of a second embodiment of a wear indicator assembly according to the present invention

FIG. 7 is a cross section view of a third embodiment of a wear indicator assembly according to the present invention; and

FIG. 8 is a cross section view of a fourth embodiment of a wear indicator assembly according to the present invention.

### DETAILED DESCRIPTION OF THE PREFERRED EMBODIMENT

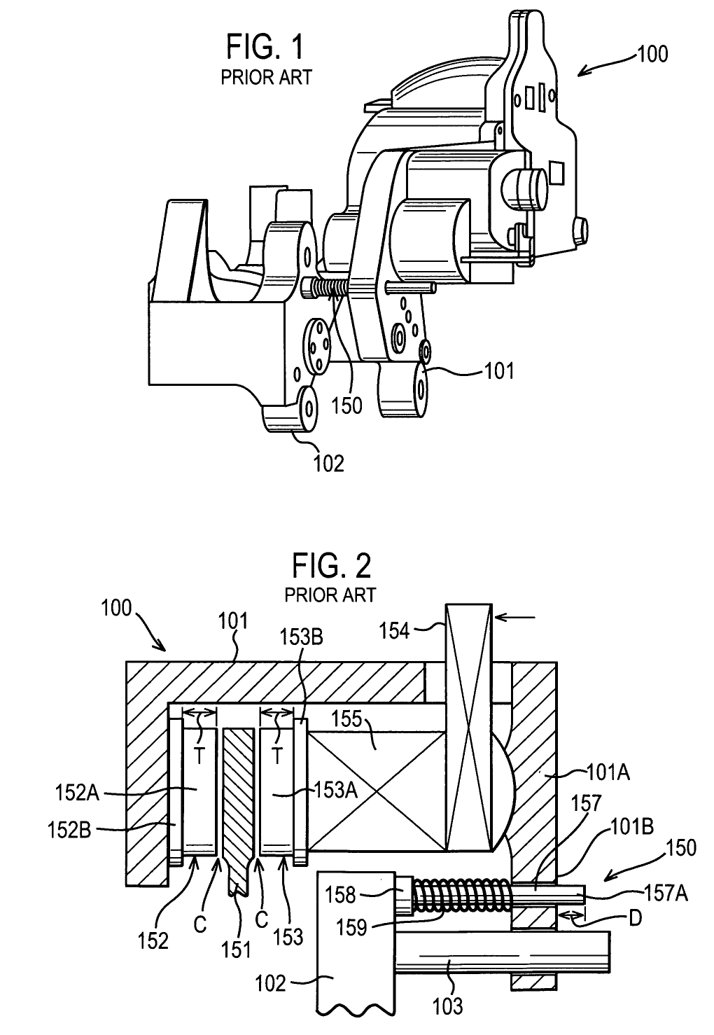

FIGS. 1 and 2 show a known brake assembly 100 having a known wear indicator 150. The main components of the brake assembly 100 are a sliding caliper 101 slideably mounted on guide pins 103 relative to a fixed carrier 102 (which is typically secured to suspension components of an associated vehicle). A brake disc 151 rotates with an associated wheel and is clamped between an outboard brake pad 152 and an inboard brake pad 153 to apply a braking force. The brake pads 152 and 153 each include friction material 152A and 153A, respectively, and a brake pad backplate 152B and 153B, respectively. A brake actuator 154 (shown schematically in FIG. 2) is operable to apply a brake force. The brake actuator 154 acts through an adjustable tappet assembly 155 (shown schematically in FIG. 2).

Actuation of the brake actuator 154 causes the adjustable tappet assembly 155 to move to the left when viewing FIG. 2, thereby forcing the brake pad 153 into engagement with the brake disc 151. A reaction force causes the sliding caliper 101 to move to the right when viewing FIG. 2, thereby engaging the brake pad 152 with the brake disc 151. In this manner, the brake disc 151 is clamped between the brake pads 152 and 153, thereby causing a friction force to slow the associated vehicle.

As shown in FIG. 2, in the “brakes off” condition, there is a running clearance C between the brake disc 151 and each brake pad 152 and 153. FIG. 2 shows the brake assembly 100 with new, unworn brake pads 152 and 153 each having a thickness T. As the outboard brake pad 152 wears, the adjustable tappet assembly 155 will automatically expand, thereby progressively moving the sliding caliper 101 to the right when viewing FIG. 2.

The wear indicator 150 is in the form of a rod 157 which projects through a hole in a sliding caliper body 101A. An outboard end of the rod 157 includes a head 158 which is biased into engagement with the fixed carrier 102 by a spring 159.

An end 157A of the rod 157 projects past a surface 101B of the sliding caliper body 101A by a distance D. Typically, the distance D would be slightly less than the thickness T. By way of example, where the thickness of the brake pad T is 20 mm, the distance D might be 18 mm.

As the brake pads 152 and 153 wear, the adjustable tappet assembly 155 automatically adjusts and expands to maintain the correct running clearance, thereby progressively causing the sliding caliper 101 to move to the right when viewing FIG. 2. Since the rod 157 is in engagement with the fixed caliper 102, the rod 157 does not move, and the spring 159 expands slightly to ensure a head 158 remains in engagement with a fixed carrier 102. As the outboard brake pad 152 wears, the distance D will decrease. When the distance D has decreased to zero, i.e., when the end 157A of the rod 157 is flush with the surface 101B, this indicates that the outboard brake pad 152 has reached its wear limit and requires replacement. In the above example, when the distance D equals zero, then the outboard brake pad 152 has 2 millimeters of friction material remaining and therefore will require changing. In view of the above explanation, it will be appreciated that the wear indicator 150 only indicates the wear condition of the outboard brake pad 152.

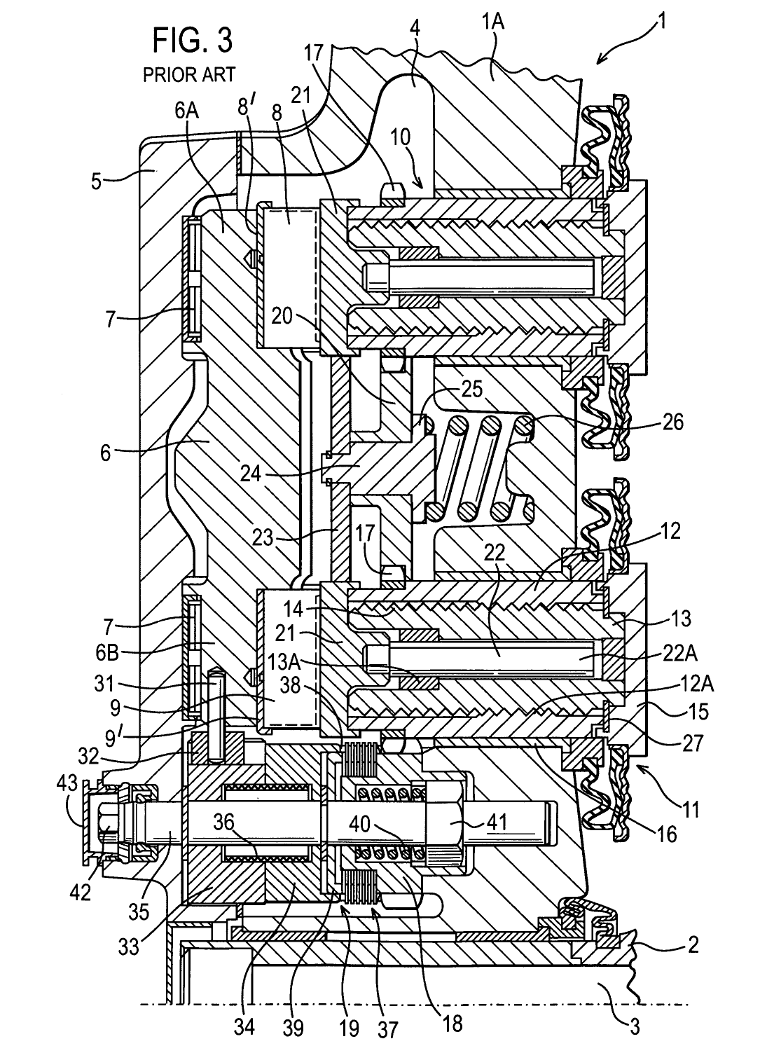

FIG. 3 shows a known brake assembly including an adjustable tappet assembly. For a full explanation of this device, the reader is referred to PCT Patent Application, PCT/GB96/01476 having publication number WO9701045. However, in summary, operation of the assembly is as follows.

FIG. 3 illustrates a sliding caliper 1 of a disc brake mounted relative to a fixed carrier 2 in a conventional manner by guide pins 3, one of which is illustrated. The sliding caliper 1 defines a chamber 4 that is closed by an end cover 5 and that houses an actuator and an adjuster mechanism, described in detail below. The disc brake includes a pair of brake pads, also known as brake linings (not shown, but similar to those shown in FIG. 2) which act on a rotor (not shown but similar to that shown in FIG. 2).

The actuator is of a type similar to that disclosed, for example in WO93/22579, as will be understood by one versed in the art. The actuator includes an eccentric member in the form of a shaft 6, rotatable, in use, by a conventional power device, such as an air actuator (not shown). The shaft 6 is rotationally supported against the end cover 5 by needle bearings 7. Portions 6A and 6B of the shaft 6 locate respective cylindrical rollers 8 and 9 which are seated in respective part-cylindrical bearings 8′ and 9′. The axes of the rollers 8 and 9 and the end portions 6A and 6B are offset from one another and form an eccentric arrangement with the rollers 8 and 9 bearing against adjacent adjustable tappet assemblies 10 and 11.

The tappet assemblies 10 and 11 are identical and only the tappet assembly 11 will be described in detail. The tappet assembly 11 includes an outer sleeve 12 which is internally threaded and has a sleeve thread 12A over a part of its length and within which is contained a shaft 13 having a complementary external thread 14 over substantially its entire length engaged with the sleeve thread 12A. An outer end of the shaft 13 includes a tappet head 15 which is releasably coupled to the shaft 13 so as, conveniently, to be freely rotatable relative to the shaft 13. The sleeve 12 is rotatably mounted in the caliper body 1A by a low friction bearing sleeve 16. The sleeve 12 is provided with an external gear form 17 which may be either a separate component firmly secured to the sleeve 12, as illustrated, or a formation integral with the sleeve 12. The gear form 17 meshes with a corresponding formation on a gear wheel 18, forming part of an adjuster mechanism 19, and also with an intermediate gear 20, which is freely rotatably mounted and located between the tappet assemblies 10 and 11.

An end abutment 21 is engaged over the end of the sleeve 12 opposite to the end that carries the tappet head 15. The end abutment 21 is rigidly connected to or integral with a pin 22 which extends within the shaft 13 and has a non-circular shape engaging within a relatively short insert 13A non-rotatably mounted within the shaft 13. The pin 22 guides the shaft 13 during axial movement of the shaft 13 between extreme retracted and extended portions thereof and also serves to prevents the shaft 13 from rotating. For this purpose, in the embodiment described, the pin 22 has a part-circular cross-section with a pair of opposed flats 22A for engagement with corresponding flats within the insert 13A. The pin 22 and the insert 13A may alternatively be non-rotatably interconnected by way of other suitable formations, providing the necessary non-rotational connection while permitting axial sliding of the shaft 13 along the pin 22. The end abutment 21 is keyed by the pin 22 and the insert 13A against rotation relative to the shaft 13, and the end abutment 21 is itself prevented from rotation by engagement with a plate member 23 which also engages, in similar manner, a corresponding end abutment 21 on the other tappet assembly 10. The plate member 23 carries a pin 24 which rotatably mounts the intermediate gear 20, and a radial flange 25 of the pin 24 provides an abutment for one end of a tappet return spring 26. The other end of the tappet return spring 26 bears against an internal surface of the caliper body 1A.

The manner of connecting the tappet head 15 to the shaft 13 is effected by way of a circlip 27 housed within a groove of the shaft 13 and engaged behind a shoulder of the tappet head 15.

The automatic adjuster mechanism 19 lengthens the tappet assembly 11 to compensate for wear of the brake friction linings. The adjuster acts on the sleeve 12 of the tappet assembly 11 and, via the intermediate gear 20, on the corresponding sleeve in the identical tappet assembly 10. The shaft 6 is linked to the adjuster by a pin 31 forming a connection between the shaft 6 and a bush 32 of the adjuster. The bush 32 is coupled to a drive sleeve assembly including two generally cylindrical sleeves 33 and 34 arranged in axial succession around an adjuster shaft 35. The sleeves 33 and 34 are frictionally interconnected by way of a wrap spring 36 arranged to engage respective internal surfaces of the components. A multi-plate clutch assembly 37 has one set of plates coupled to a cylindrical extension 38 of the sleeve 34 and another set of plates connected to an intermediate component 39 mounted on the adjuster shaft 35. The multi-plate clutch assembly 37 is also in driving engagement with the gear wheel 18 previously referred to, the clutch being pre-loaded by a spring 40. The normal running clearance of the brake is provided for by the clearance between the sleeve 34 and the part of the clutch assembly 37 engaged with the sleeve 34. The adjuster shaft 35 includes an inner hexagon formation 41 engaged with a corresponding internal formation within the gear wheel 18, and the adjuster shaft 35 thus rotates permanently with the gear wheel 18. The outer end of the adjuster shaft 35 is also provided with a drive formation 42 which, in this embodiment, is hexagonal. This formation is normally disposed within a protective cap 43, which is securely mounted in the housing and removable to permit adjusting rotation of the adjuster shaft 35 by way of the drive formation 42.

Actuation of the brake by rotation of the shaft 6 rotates the sleeves 33 and 34. The movement of the tappet assemblies 10 and 11 does not exceed the nominal brake clearance as would be the case, for example, with the linings in new condition. The sleeves will merely move by the amount of the built-in clearance and return to their original positions, without adjustment occurring. When the friction lining wear results in rotational movement of the sleeve 34 by an amount greater than the built-in clearance, the clutch rotates, together with the intermediate component 39 and the gear wheel 18, thereby rotating the tappet sleeves 12 in a direction to wind out the shafts 13 and thereby lengthen the strut assemblies by an amount equal to the excess actuator movement. If the sliding caliper 1 is subjected to loads high enough to cause deflection of the brake components, operation of the adjustment will be prevented by slipping of the multi-plate clutch assembly 37 at a predetermined torque representing a maximum permitted load.

Release of the brake results in return movement of the tappet assemblies 10 and 11 under the action of the return spring 26, such return movement being accompanied by slipping of the multi-plate clutch until the applied torque is such that the clutch is held in its non-slipping condition. Continued rotation of the sleeves 33 and 34 enables the brake clearance to be reset and, if adjustment has occurred, the final part of the return stroke of the shaft 6 will be accompanied by relative slipping between the sleeves 33 and 34 as permitted by the wrap spring 36. The mechanism is thereby set for a subsequent brake application. In particular, the sliding caliper 1 does not include a brake pad wear indicator.

Certain components within the sliding caliper 1 rotate substantially in proportion to the total amount of wear of the associated brake pads (also known as first and second brake pads; note the comments below in respect of wear of the brake disc). Thus, the adjuster shaft 35, the gear wheel 18, both the external gear forms 17, and the intermediate gear 20 all rotate substantially in proportion to the total wear of the brake pads. The applicant is the first to realize that where a component of an adjuster mechanism rotates substantially in proportion to the total wear of the brake pads, the component can be utilized to drive a wear indicator.

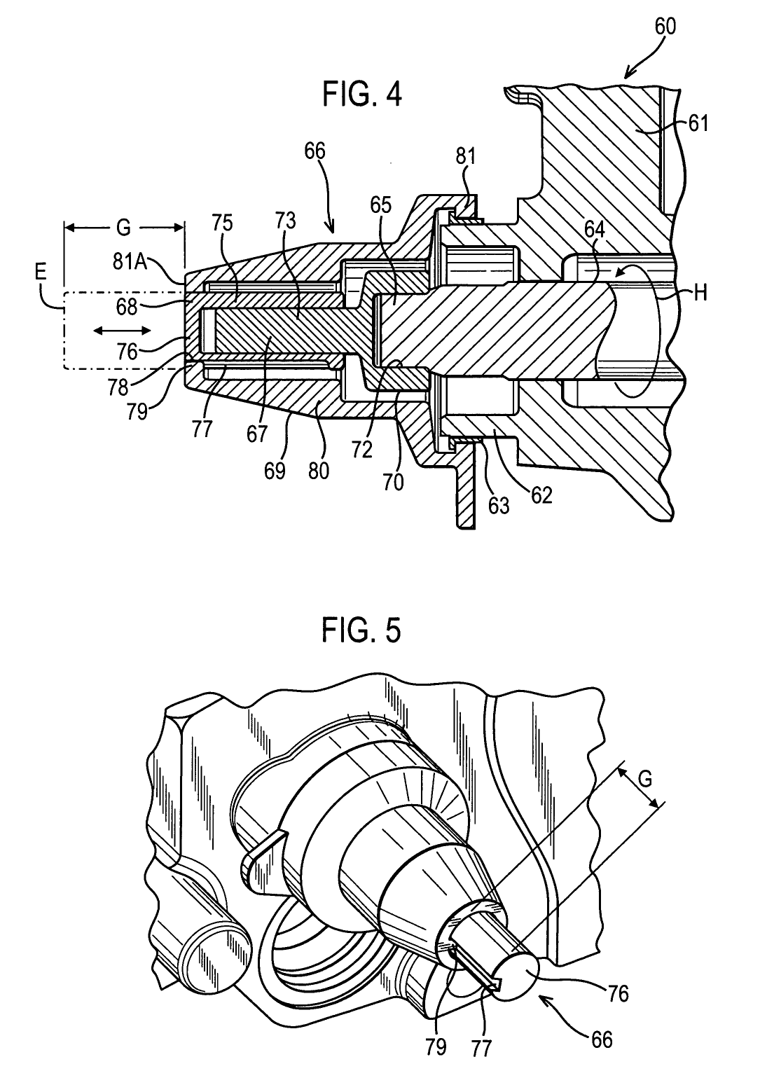

A particularly cost effective method of providing a wear indicator is shown in FIGS. 4 and 5. A brake assembly 60 (only part of which is shown) includes a sliding caliper 61 (which typically might be similar to the sliding caliper 1). The sliding caliper 61 includes an annular boss 62 having a ring retainer 63 secured to the annular boss 62, typically by providing an interference fit between the annular boss 62 and the ring retainer 63. The brake assembly 60 includes an adjuster mechanism, only part of which (a manual adjuster shaft 64) is shown. Typically, the manual adjuster shaft 64 might be similar to the manual adjuster shaft 35. The manual adjuster shaft 64 includes a drive formation, in this case in the form of a hexagonal head 65. A wear indicator assembly 66 includes a first component 67, a second component (an indicator pin 68) and a manual adjuster shaft cap 69. The first component 67 includes a boss 70 having a hexagonal recess 72 for engagement with the head 65 to rotatably secure the first component 67 to the manual adjuster shaft 64. A shaft 73 projects from the boss 70 and includes an external shaft thread (not shown).

The indicator pin 68 includes a generally cylindrical body 75 having an internal body thread (not shown) that is in threaded engagement with the external shaft thread. The cylindrical body 75 has a closed end 76 and includes a longitudinal groove 77 (best seen on FIG. 5) on the outside of the cylindrical body 75.

The manual adjuster shaft cap 69 includes an end hole 78 for slideably supporting the indicator pin 68. The end hole 78 is generally circular but includes an anti-rotation feature in the form of a projection 79 that engages the longitudinal groove 77 and prevents rotation of the indicator pin 68 relative to the manual adjuster shaft cap 69. The manual adjuster shaft cap 69 includes a cap body 80 which generally surrounds the indicator pin 68, the first component 67, the hexagonal head 65 of the manual adjuster shaft 64 and part of the annular boss 62. An annular portion 81 of the manual adjuster shaft cap 69 sealingly engages the ring retainer 63 and prevents rotation of the manual adjuster shaft cap 69 relative to the sliding caliper 61. The cap body 80 includes a flat annular region 81A that surrounds the end hole 78.

Because the indicator pin 68 is a close fit within the end hole 78, the manual adjuster shaft cap 69 together with the indicator pin 68 protect the first component 67 and the manual adjuster shaft 64 from the ingress of dirt, dust, water, etc.

Assembly and operation of the wear indicator assembly 66 is as follows. For the purposes of this example, the brake assembly 60 is assumed to have a new set of brake pads, and the manual adjuster shaft 64 is adjusted to give the correct running clearance between the rotor and the pads.

Once this has been done, the hexagonal recess 72 of the first component 67 is fully engaged with the hexagonal head 65 of the manual adjuster shaft 64. The head 65 has a tight fit in the recess 72, thereby ensuring that the first component 67 remains fixed axially relative to the manual adjuster shaft 64 during subsequent operation of the brake.

The indicator pin 68 is then threadingly engaged with the externally threaded shaft 73 and rotated until the closed end 76 lies at the chain dotted position indicated at E. The manual adjuster shaft cap 69 is then fitted over the indicator pin 68 such that the projection 79 engages in and is slid along the longitudinal groove 77 and the annular region 81 is engaged behind the ring retainer 63, thereby securing the manual adjuster shaft cap 69 rotatably fast with the annular boss 62 of the sliding caliper 61.

FIGS. 4 and 5 show the wear indicator assembly 66 with the closed end 76 projecting from the flat annular region 81A via a distance G. Once assembled and the associated vehicle is used, the brake pads will progressively wear. The adjuster mechanism will compensate for the wear and cause the manual adjuster shaft 64 to rotate in the direction of arrow H. This in turn will cause the first component 67 to rotate by an equivalent amount. In the present example, the external shaft thread and the internal body thread are right hand threads.

As mentioned above, the manual adjuster shaft cap 69 and the indicator pin 68 are prevented from rotating. Thus, as the brake pads wear, the threaded engagement between the first component 67 and the indicator pin 68 will progressively draw the indicator pin 68 inwardly, thereby reducing the distance G. The reduction in the distance G is substantially proportional to the total amount of pad wear on the inner and outer brake pads.

The amount by which the manual adjuster shaft 64 rotates per 1 millimeter of total brake pad wear depends upon the particular gearing of the associated adjuster mechanism.

For example, the adjuster mechanism gearing could be such that if the inboard and outboard brake pads each wear by ½ millimeter (i.e., a total of 1 millimeter of brake pad wear), then the manual adjuster shaft 64 could rotate through 360 degrees. Using this example, the thread pitch of the external shaft thread and the internal body thread could be ½ millimeter. Under the circumstances, if both brake pads wear 1 millimeter, then the distance G will reduce by 1 millimeter.

Furthermore, the distance G can serve as a direct indicator of the total amount of friction material remaining on each brake pad. When the closed end 76 becomes flush with the flat annular region 81A, the brake pads will require changing. If each brake pad has 20 millimeters of friction material thickness and the distance G is set at 18 millimeters with new brake pads, the pads require changing when the distance G becomes zero (i.e., when the closed end 76 becomes flush with the flat annular region 81A) since they will each have only 2 millimeters of friction material remaining and continued running of the vehicle risks metal to metal contact between the disc and brake pad backplate, which is a safety hazard.

The alternative gearing of the adjuster mechanism, and/or an alternative thread pitch of the first component 67 and the indicator pin 68 will produce a wear indicator wherein the distance G may reduce either faster or slower than the wear on a brake pad. Furthermore, the wear limit need not be indicated by the closed end 76 becoming flush with the flat annular region 81A.

As mentioned above, the head 65 has a tight fit in the recess 72, thereby ensuring that the first component 67 does not move to the left when viewing FIG. 4 as the brake pads wears. In an alternative embodiment, the head 65 could have a non-interference fit in the recess 72 with an inner shoulder of the manual adjuster shaft cap 69 being located proximate the boss 70 to ensure that the first component 67 does not move to the left during adjuster operation.

As mentioned above, as the brake pads wear, the indicator pin 86 moves towards the associated caliper. If the external shaft thread and the internal body thread are provided as left hand threads in a further embodiment, then the wear indicator assembly 66 could be set up with the closed end of the indicator pin 68 flush with the flat annular region 81A when the brake pads are new. As the brake pads wear, the indicator pin 68 will progressively project from the flat annular region 81A. Under these circumstances, the wear limit of the brake pads could be indicated by a color change on the indicator pin 68. Thus, the outermost 18 millimeters of the indicator pin 68 could be colored green, with the remainder of the indicator pin 68 being colored red. As the brake pads reach their wear limit, then the red color of the indicator pin 68 would start to show, thereby indicating that the brake pad needs to be changed.

An alternative way of assembling the wear indicator assembly 66 is to assemble the first component 67, the indicator pin 68 and the manual adjuster shaft cap 69 together remotely from the caliper such that the closed end 76 is positioned at the distance G from the flat annular region 81A (i.e., the wear indicator assembly 66 is preset to an unworn pad condition prior to assembly) and then assemble the wear indicator assembly 66 onto the sliding caliper 61 by substantially simultaneously engaging the recess 72 with the hexagonal head 65 and the annular portion 81 around the ring retainer 63. This is particularly advantageous when the wear indicator assembly 66 is provided as a kit of parts together with replacement brake pads (see below).

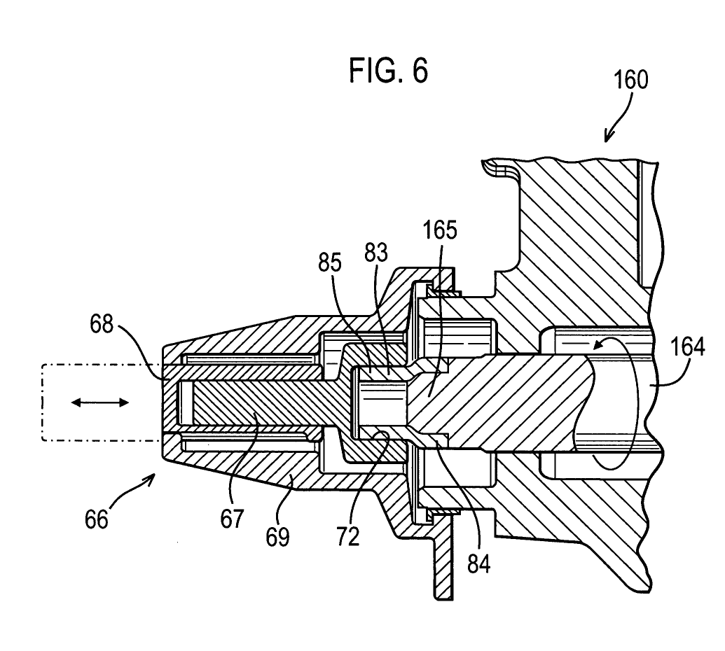

FIG. 6 shows a second embodiment of a brake assembly 160 which includes the wear indicator assembly 66 of FIG. 4. However, in this case, the hexagonal recess 72 of the first component 67 engages a torque limiting device 83 which in turn engages a drive formation in the form of a hexagonal head 165 of a manual adjuster shaft 164. Torque limiting devices per se are known, and examples can be found in UK Patent GB2304387 and German Patent DE19923457C1. In summary, the torque limiting device 83 has a region 84 that engages the head 165 and a region 85 that is designed to be engaged by a tool, such as a spanner or hexagonal socket.

The torque limiting device 83 operates to prevent damage to the caliper as follows. When the brake pads have worn down to their service limit, they must be removed. To be able to insert the new, thicker brake pads, the adjuster mechanism must be de adjusted, and this is typically done by manually rotating the manually adjuster shaft 164. This is done by removing the wear indicator assembly 66 and engaging a socket on the region 85 of the torque limiting device 83. Rotation of the socket causes the torque limiting device 83 to rotate the manual adjuster shaft 164. However, if too much torque is inadvertently applied to the socket, then the torque limiting device 83 will prevent excess torque being applied to the manual adjuster shaft 164, typically by shearing in half. While the torque limiting device 83 may have been irreparably damaged under such circumstances, it is nevertheless an inexpensive component, and the failure of the torque limiting device 83 is immediately obvious to the operator. This is advantageous since, without the torque limiting device 83, there is a possibility of damaging an expensive internal component of the adjuster mechanism or the brake caliper, and any such damage may not be immediately obvious, thereby causing a safety hazard. Embodiments of torque limiting devices shown in UK patent GB2304387 and German patent DE19923457C1 and other designs of torque limiting devices may be used on conjunction with the present invention.

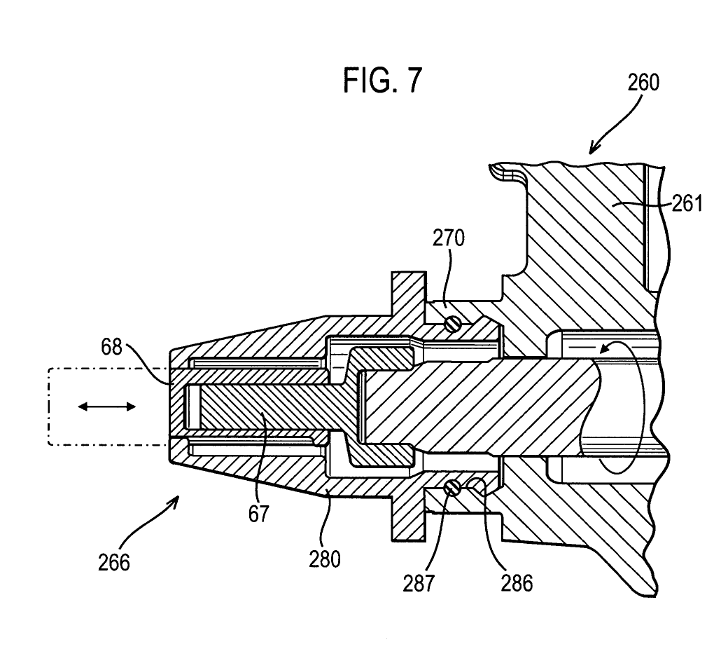

FIG. 7 shows a third embodiment of a wear indicator assembly 266 which includes a first and second component identical to those shown in FIG. 4, but in this case a manual adjuster shaft cap body 280 sealingly engages in a recess 286 of a boss 270 of a sliding caliper 261. An elastomeric o-ring 287 provides sealing.

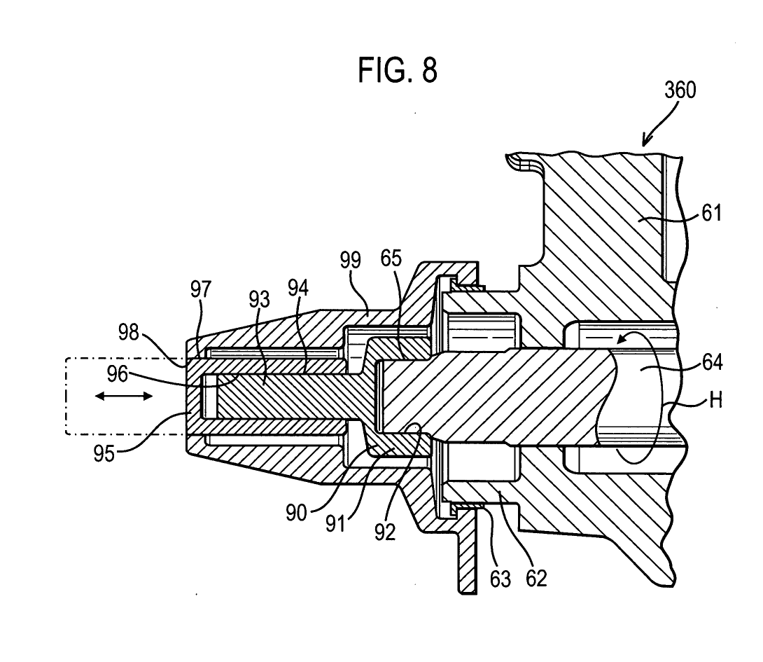

FIG. 8 shows a fourth embodiment of a wear indicator assembly 360. The sliding caliper 61, the ring retainer 63 and the manual adjuster shaft 64 are identical to those shown in FIG. 4. The wear indicator assembly 360 includes a drive pin 90 having a boss 91 (similar to the boss 70) with a recess 92 (similar to the recess 72). However, a shaft 93 has a hexagonal cross section which acts as a drive formation 94. The drive formation 94 slidingly engages a hexagonal recess 96 in an indicator pin 95. An external surface 97 of the indicator pin 95 is threaded and threadingly engages a threaded internal surface of an end hole 98. A manual adjuster shaft cap 99 is rotationally fast with the sliding caliper 61. The indicator pin 95 and the drive pin 90 are both rotationally fast with the manual adjuster shaft 64. In this case, the external thread on the indicator pin 95 and the internal thread in the end hole 98 are both left hand threads. Thus, as the manual adjuster shaft 64 rotates in the direction of arrow H as the brake pads wear, the indicator pin 95 progressively is withdrawn into the manual adjuster shaft cap 99 in a manner similar to the embodiment shown in FIG. 4. In one embodiment, the pad wear indicator can be designed such that the end of the indicator pin 95 (the first component) becomes flush with the flat region on the end of the manual adjuster shaft cap 99 (the second component) when the brake pads require changing.

In a further embodiment, the external thread on the indicator pin 95 on the internal thread in the end hole 98 could be right hand threads, in which case the indicator pin 95 will progressively project from the manual adjuster shaft cap 99 as the brake pads wear.

The indicator assembly shown in FIGS. 4, 6, 7 and 8 all indicate brake pad wear by moving in a linear direction. The present application is not limited to linear movement of a wear indicator assembly, and in particular wear could be indicated by rotation of a particular component.

The adjuster mechanisms described compensate for wear in both the inboard and outboard brake pads. Where an adjuster mechanism only compensate for wear of one brake pad, then a wear indicator assembly could be utilized with such an adjuster mechanism to indicate the wear on the associated brake pad.

The present invention provides a system whereby a known caliper which does not include a wear indicator and which is in use (i.e., which is already fitted to a vehicle and the vehicle is being used) can be retrofitted with a wear indicator assembly. Thus, considering FIG. 3, the protective cap 43 can be removed and can be replaced with a wear indicator assembly similar to the wear indicator 226 of FIG. 7 (though adapted to suit the installation) in a simple and inexpensive manner. A particularly advantageous time to make such an adaptation would be when the brake pads are being renewed. Typically, brake pads are supplied as an axle set (e.g., where the axle has two braked wheels then four brake pads are supplied). The present invention provides for a simple method of providing a wear indicator assembly on an in-use brake caliper by providing a kit of parts including an axle set of brake pads (or alternatively a wheel set of brake pads) and an appropriate number of wear indicator assemblies. Such a kit allows for the replacement of the brake pads of each brake and also for a wear indicator assembly on each brake during servicing of the brakes.

Whenever components are retrofitted onto an existing vehicle, then the available space envelope must be able to accommodate the new components. The applicant is the first to realize that where existing brake calipers having deadjuster mechanisms are fitted to a vehicle, then there will inevitably be a free space in the vicinity of the deadjuster mechanism to allow access for deadjusting tools (such as spanners or sockets) and also a space available for the operator's hand to manipulate such tools. The present invention takes advantage of this free space by positioning the wear indicator in the free space.

Thus, a designer designing a wear indicator according to the present invention for retrofit on a particular brake caliper will almost certainly be assured of an appropriate free space in which to situate the wear indicator. Also, the designer may well be able to utilize a wear indicator from another design of brake caliper since the space envelope required for the wear indicator is considerably less than the free space required for the deadjusting tool and the operator's hand.

In particular, the present invention provides for a method of servicing a brake assembly having a wear indicator according to the present invention. In summary, the method includes the steps of removing the worn brake pad, removing the wear indicator assembly (or in further embodiments at least a part of the wear indicator assembly), manually deadjusting the adjuster mechanism, inserting the new brake pads and replacing the wear indicator assembly. The present invention also provides a brake assembly having two wear indicator assemblies.

Thus, the prior art brake assembly shown in FIG. 1 includes a wear indicator 150 that indicates the wear on the outboard brake pad. If the brake assembly of FIG. 1 is provided with a wear indicator assembly according to the present invention, then the wear indicator assembly will indicate the total amount of wear on both the inboard and outboard brake pads. Advantageously, this provides for a system whereby the wear on the inboard pad can be deduced. Thus, if the prior art brake assembly shown in FIG. 2 is provided with a wear indicator assembly as shown in FIG. 4 and (using the above example) with new 20 millimeter thick brake pads, the distance G is set at 18 millimeters and the distance D is set at 18 millimeters, then if the brake pads wears evenly, then the distance D will reduce at the same rate as the distance G (assuming the gearing as mentioned in the above example). However, if the outboard pad wear faster then the inboard pad, then the distance D will reduce at a faster rate than the distance G, thereby indicating the outboard pad is wearing faster than the inboard pad. Conversely, if the inboard pad wears faster than the outboard pad, then the distance G will reduce faster than the distance D, again indicating uneven pad wear.

As mentioned above, the adjuster mechanisms compensate for wear of brake pads. Wear of the brake disc also occurs, though typically at a slower rate than wear of brake pads. Thus, by way of example, a brake disc might wear through to two sets of brake pads before the disc itself requires replacing. Thus, the known wear indicator 150 shown in FIG. 2 actually indicates the combined wear of the outer brake pad and the wear of the outboard disc face. However, such a system errs on the side of caution since when the distance D has reduced to zero (thereby indicating pad replacement) because the brake disc outer face will have worn slightly, and the outboard brake pad thickness will be slightly greater than anticipated.

Similarly, where an adjuster mechanism of the present invention normally compensates for wear of two brake pads, any wear on the outboard or inboard face of the brake disc will also be compensated for. Thus, again the indicator assembly of the present invention errs on the side of caution since when the indicator assembly indicates that the brake pads require renewing, in fact the brake pads will have slightly more friction material than anticipated.

As described above, the first component 67 is separate from the manual adjuster shaft 64, though in further embodiments these components could be integrally formed as a single component.

The first component 67 has an external thread, and the indicator pin 68 has an internal thread. In further embodiments, the first component 67 could have an internal thread and the indicator pin 68 could have an external thread, and such threads could either be right hand threads or left hand threads. As shown in FIG. 8, the indicator pin 68 is provided by the manual adjuster shaft cap 99, which is sealingly engaged with the outside of a boss of the sliding caliper 61. In a further embodiment, the indicator pin 68 could sealingly engage the inside of a recess of a sliding caliper 61 (for example, in a manner similar to the way in which the cap body 80 engages the inside of the boss 270 of FIG. 7).

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A brake assembly comprising:
a caliper;
a first brake pad;
an actuator to force the first brake pad into engagement with a rotor; and
an adjuster mechanism to compensate for wear of the first brake pad, wherein the adjuster mechanism includes a rotating component that rotates substantially in proportion to an amount of wear of the first brake pad and is manually operable to deadjust the adjuster mechanism when replacement of the first brake pad is required, and the rotating component is operably coupled to a pad wear indicator mounted on the caliper which visually indicates the amount of wear of the first brake pad.

2. The brake assembly as defined in claim 1 further including a second brake pad, wherein the actuator forces the second brake pad into engagement with the rotor and the rotating component rotates substantially in proportion to a total amount of wear of the first brake pad and the second brake pad, and the pad wear indicator indicates the total amount of wear of the first brake pad and the second brake pad.

3. The brake assembly as defined in claim 2 wherein the pad wear indicator indicates the total amount of wear by moving linearly, and linear movement of the pad wear indicator is approximately equal to half the total amount of wear of both the first brake pad and the second brake pad.

4. The brake assembly as defined in claim 2 including a further wear indicator that indicates a wear condition of only one of the first brake pad and the second brake pad.

5. The brake assembly as defined in claim 1 wherein the pad wear indicator indicates the amount of wear of the first brake pad by moving linearly.

6. The brake assembly as defined in claim 1 wherein the rotating component is a manual adjuster shaft including a head to manually deadjust the adjuster mechanism.

7. The brake assembly as defined in claim 6 wherein the pad wear indicator includes a first component and a second component in threaded engagement, and the first component engages the head of the manual adjuster shaft.

8. The brake assembly as defined in claim 7 wherein one of the first component and the second component moves towards the caliper as the first brake pad wears.

9. The brake assembly as defined in claim 7 wherein one of the first component and the second component moves away from the caliper as the first brake pad wears.

10. The brake assembly as defined in claim 6 wherein the pad wear indicator includes a first component and a second component in threaded engagement, the first component engages a torque limiting device to limit an amount of torque that can be applied to the manual adjuster shaft and the torque limiting device engages the head of the manual adjuster shaft.

11. The brake assembly as defined in claim 1 wherein the pad wear indicator includes a first component and a second component in threaded engagement, wherein the first component is rotatably fast with the rotating component and the second component is rotatably fast with the caliper and one of the first component and the second component indicates the amount of wear of the first brake pad.

12. The brake assembly as defined in claim 11 wherein the second component acts as a manual adjuster shaft cap.

13. A wear indicator assembly for mounting on a brake assembly comprising:
a caliper;
a brake pad;
an actuator to force the brake pad into engagement with a rotor; and
an adjuster mechanism to compensate for wear of the brake pad, the adjuster mechanism including a rotating component that rotates substantially in proportion to an amount of wear of the brake pad,
wherein the wear indicator assembly indicates the amount of wear of the brake pad and includes a first component and a second component in threaded engagement, wherein the first component is securable rotationally fast with the rotating component and the second component is securable rotationally fast with the caliper, wherein one of the first component and the second component indicates the amount of wear of the brake pad.

14. A repair kit comprising:
a plurality of wheel sets of brake pads; and
a respective number of wear indicator assemblies for mounting on a brake assembly, wherein each of the respective number of wear indicator assemblies includes:
a caliper;
a brake pad;
an actuator to force the brake pad into engagement with a rotor; and
an adjuster mechanism to compensate for wear of the brake pad, the adjuster mechanism including a rotating component that rotates substantially in proportion to an amount of wear of the brake pad,
wherein the wear indicator assembly indicates the amount of wear of the brake pad and includes a first component and a second component in threaded engagement, wherein the first component is securable rotationally fast with the rotating component and the second component is securable rotationally fast with the caliper, wherein one of the first component and the second component indicates the amount of wear of the brake pad.

15. The repair kit as defined in claim 14 wherein each of the respective number of wear indicator assemblies is preset to an unworn brake pad condition.

16. The repair kit as defined in claim 14 further including at least one torque limiter and the adjuster mechanism includes a manual adjustable shaft having a head, wherein the at least one torque limiter is engageable with the head of the manual adjuster shaft and operable to limit an amount of torque applied to the manual adjuster shaft.

17. A method of servicing a brake assembly comprising the steps of:
rotating a rotating component of an adjuster mechanism substantially in proportion to an amount of wear of a brake pad, wherein the rotating component is manually operable to deadjust the adjuster mechanism when replacement of the brake pad is required, and the adjuster mechanism compensates for wear of the brake pad;
operably coupling the rotating component to a pad wear indicator mounted on a caliper which visually indicates the amount of wear of the brake pad;
removing a worn brake pad;
removing at least a part of the pad wear indicator to provide access to the rotating component;
rotating the rotating component to deadjust the adjuster mechanism inserting an unworn brake pad; and
replacing the at least a part of the pad wear indicator.
